(19) United States
(12) Patent Application Publication
(10) Pub. No.: US 2015/0160854 A1
(43) Pub. Date: Jun. 11, 2015

(54) INPUT APPARATUS, INPUT DETERMINATION METHOD, AND RECORDING MEDIUM STORING PROGRAM

(71) Applicant: Konica Minolta, Inc., Tokyo (JP)

(72) Inventors: Kenta HOSAKA, Sagamihara-shi (JP); Takamasa NIWA, Tokyo (JP); Masayuki INOUE, Tokyo (JP); Yasuhiko YAMAGUCHI, Tokyo (JP); Keiichiro HYODO, Tokyo (JP); Tetsuhiro SHIBATA, Hamamatsu-shi (JP)

(21) Appl. No.: 14/560,600

(22) Filed: Dec. 4, 2014

(30) Foreign Application Priority Data
Dec. 10, 2013 (JP) 2013-255334

(51) Int. Cl. G06F 3/0488; G06F 3/041

(52) U.S. Cl. CPC G06F 3/04883; G06F 3/0416; G06F 3/0488; G06F 2203/04106

(57) ABSTRACT

An input apparatus includes: a held state detection unit configured to detect a held state of an own apparatus; an input detection unit including a detection surface configured to detect an input performed by contact with an input member; a determination unit configured to perform determination related to the input detected by the input detection unit; and a determination reference setting unit configured to set, according to the held state detected by the held state detection unit, a determination reference used by the determination unit for the determination.

The entire disclosure of Japanese Patent Application No. 2013-255334 filed on Dec. 10, 2013 including description, claims, drawings, and abstract are incorporated herein by reference in its entirety.

### BACKGROUND OF THE INVENTION

1. Field of the Invention

The present invention relates to an input apparatus or the like which receives a handwriting input performed with a finger, a pen, or the like.

2. Description of the Related Art

A mobile terminal such as a smartphone or a tablet terminal is sometimes used while being placed on a table but is often used while being held by a hand. In a case where the mobile terminal is used while being held by a hand, there are various ways to hold the mobile terminal. For example, there is a case where the mobile terminal is held in such a manner that a long side of a rectangular display region becomes vertical or horizontal.

Thus, various techniques to improve operability and usability by detecting a way the terminal is held (grasped state) by a built-in gyroscope, camera, or the like and by switching a function or a display according to the grasped state have been proposed.

For example, there is a technique to move an icon to an upper side of a screen in a front view in such a manner that operation can be easily performed with an index finger or the like of a holding hand when it is detected that the mobile terminal is used while being held by a hand (see Japanese Laid-Open Patent Publication No. 2012-203761).

Also, in a case where a part of a great number of touch sensors arranged, for example, in a circular manner is pressed by a finger holding the terminal, there is a technique to assign a predetermined function to a touch sensor at a position suitable for a current held state among the remaining touch sensors which are not pressed by the grasping finger (see Japanese Laid-Open Patent Publication No. 2012-083976).

Also, there is a technique to make it possible to rest a thumb or the like on a touch invalidation region by determining whether a mobile phone is held by one hand or both hands and by invalidating touch operation on a part of a touch screen in a case where the mobile phone is held by one hand (see Japanese Laid-Open Patent Publication No. 2011-028603).

In addition, there is a technique to determine whether a terminal such as a smartphone is held with along side of a display screen being in a vertical state or in a horizontal state based on which part of the display screen is touched by a holding finger and to switch permitting and not permitting a rotation of the screen (see Japanese Laid-Open Patent Publication No. 2013-097400 (WO 2013/61658 A).

There is an input apparatus such as a tablet terminal on which a handwriting input is performed with a pen or a finger which apparatus includes a function to determine, for example, whether an input is performed with a pen, a finger, or an eraser based on a load received during the input and to switch processing according to a result of the determination. For example, when it is determined that the input is performed with a pen, an input trace is additionally displayed. When it is determined that the input is performed with an eraser, a display of a part corresponding to the input trace is erased. When it is determined that the input is performed with a finger, operation contents such as a flick and a pinch-out are determined and corresponding processing is performed.

FIG. 20 is a view illustrating an example of a change in writing pressure (load received on input surface) of when a handwriting input is performed with a pen 200a while an input apparatus 10′ such as a tablet terminal, on a detection surface S of which paper P is placed, is placed on a table, a load range in which it is determined that an input is performed with a pen, a load range in which it is determined that the input is performed with an eraser, and a load range in which it is determined that the input is performed with a finger.

Incidentally, writing pressure of when handwriting input is performed on an input apparatus such as a tablet terminal is different between a case where the handwriting input is performed with the tablet terminal or the like being placed on a table and a case where the handwriting input is performed with the tablet terminal or the like being held by a hand. For example, in a case where the input apparatus is held by a hand, a securely-supported range becomes narrow compared to that in a case where the input apparatus is placed on a table. Thus, the input apparatus is pushed by a load of a pen and a user tries to support the terminal securely against the pushing, and thus, a variation range of the load becomes wide compared to that in a case where the input apparatus is placed on a table, as illustrated in FIG. 21.

Accordingly, in a state in which an input apparatus is held by a hand, when it is determined whether an input is performed with a pen while a determination reference which is the same as that in a case where the input apparatus is placed on a table is applied, it may not be determined that the input is performed with a pen or it may be determined that the input is performed with a different input member (such as eraser) even when the input is performed by a pen. When it is determined that the input is performed with the different input member, processing corresponding to the different input member may be performed by mistake.

Note that an influence on the handwriting input due to a held state is not limited a variation of a load range. For example, a size of deviation of a trace generated when a straight line is handwritten also varies due to a held state. Thus, for example, when correction processing to correct deviation in a certain range and to replace with a straight line is performed, a held state influences a determination reference thereof.

The techniques disclosed in Japanese Laid-Open Patent Publication No. 2012-203761, Japanese Laid-Open Patent Publication No. 2012-083976, Japanese Laid-open Patent Publication No. 2011-028603, and Japanese Laid-Open Patent Publication No. 2013-097400 (WO 2013/61658 A) are to switch a display position of an icon or setting of a touch invalidation region depending on a held state and do not correspond to the above described problem.

### SUMMARY OF THE INVENTION

The present invention has been made to solve the above problem and an object thereof is to provide an input apparatus, an input determination method, a recording medium storing a program which are capable of performing determination related to a handwriting input regardless of a held state.

To achieve at least one of the abovementioned objects, according to an aspect, an input apparatus reflecting one aspect of the present invention comprises: a held state detection unit configured to detect a held state of an own apparatus, an input detection unit including a detection surface configured to detect an input by an input member, a determination unit configured to perform determination related to the input detected by the input detection unit, and a determination reference setting unit configured to change, according to the held state detected by the held state detection unit, a determination reference used by the determination unit for the determination.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1A and FIG. 1B are views illustrating configuration examples of an input apparatus according to an embodiment of the present invention;

FIG. 2 is a block diagram illustrating a schematic configuration of the input apparatus according to the embodiment of the present invention;

FIG. 3A and FIG. 3B are views illustrating an example of various types of an input unit and an input load detection unit of the input apparatus according to the embodiment of the present invention;

FIG. 4A and FIG. 4B are views illustrating an example of various types of the input unit and the input load detection unit of the input apparatus according to the embodiment of the present invention;

FIG. 5 is a view illustrating a variation range of a load (writing pressure) in a case where an input performed with a pen is received while the input apparatus is placed on a table;

FIG. 6 is a view illustrating a variation range of a load (writing pressure) in a case where an input performed with an eraser is received while the input apparatus is placed on a table;

FIG. 7 is a view illustrating a variation range of a load (writing pressure) in a case where an input performed with a finger is received while the input apparatus is placed on a table;

FIG. 8A to FIG. 8D are views respectively illustrating variation ranges of a load (writing pressure) in a case where various kinds of operation performed with a finger are received while the input apparatus is placed on a table;

FIG. 9 is a view illustrating a state in which a user holds the input apparatus with a non-dominant hand in such a manner to grasp around an end on an opposite side of a dominant hand;

FIG. 10 is a view illustrating a state in which a detection surface of the input apparatus is divided into a plurality of regions according to the held state illustrated in FIG. 9 and illustrating a load range in a case where handwriting is performed in each of the regions with a pen;

FIG. 11 is a view illustrating division into regions in the held state illustrated in FIG. 9 and a load range in a case where Pinch operation performed with a finger is received in each region;

FIG. 12A to FIG. 12C are views illustrating various ways of holding by a hand;

FIG. 13A to FIG. 13C are views illustrating a plurality of regions divided in each of the held states illustrated in FIG. 12A to FIG. 12C;

FIG. 14A to FIG. 14C are views illustrating a variation range of a load and a determination reference value (load range) in a case where handwriting is performed with an input member (pen, eraser or finger) on a strong oscillation region in each of first to third held states;

FIG. 15A to FIG. 15D are views illustrating load ranges relative to various kinds of operation in a case where input operation is performed with a finger in the strong oscillation region in different held states;

FIG. 16 is a flowchart illustrating an outline of whole processing performed by the input apparatus;

FIG. 17 is a flowchart illustrating processing by the input apparatus to set a determination reference value according to a held state of the own apparatus;

FIG. 18 is a table illustrating an example of a determination reference value table;

FIG. 19 is a flowchart illustrating a detail of step S102 in FIG. 16;

FIG. 20 is a view illustrating a change in writing pressure in a case where a handwriting input is performed by using a pen, an eraser, and a finger in a state in which the input apparatus such as a tablet terminal is placed on a table and illustrating a load range to be a determination reference of a pen, an eraser, or a finger; and

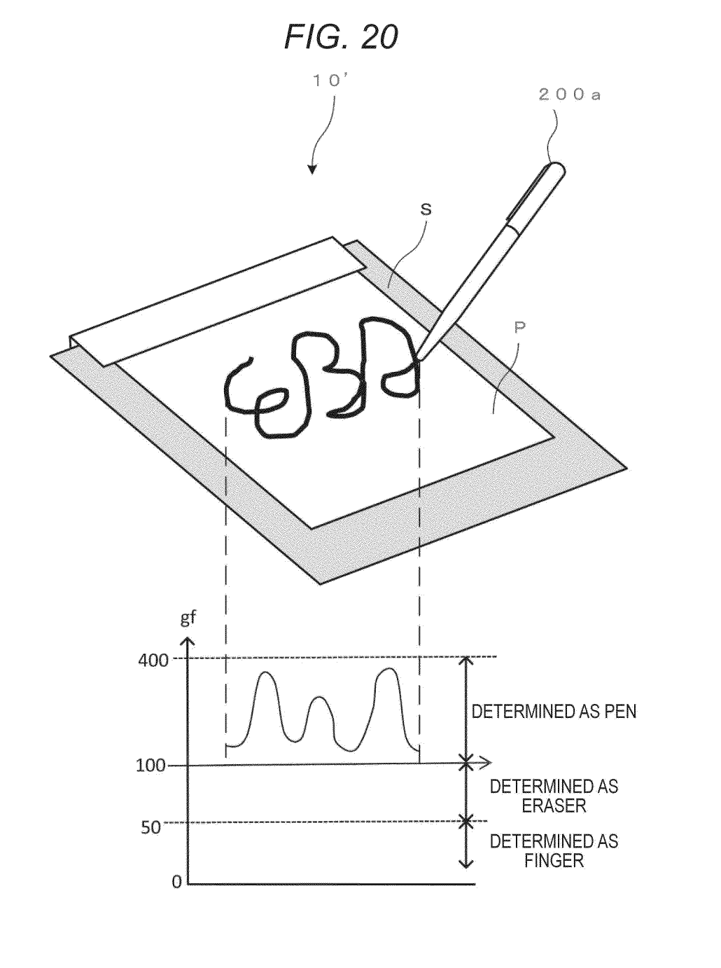

FIG. 21 is a view illustrating a change in writing pressure in a case where the handwriting input is performed by using a pen, an eraser, or a finger in a state in which the input apparatus such as a tablet terminal is held by a hand.

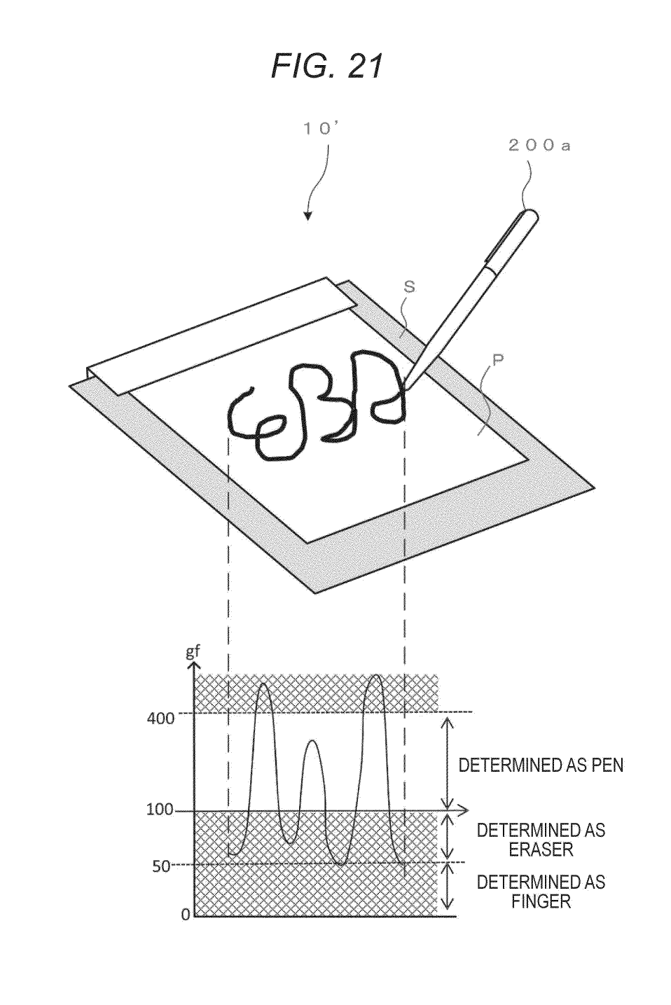

### DESCRIPTION OF THE PREFERRED EMBODIMENTS

Hereinafter, an embodiment of the present invention will be described with reference to the drawings. However, the scope of the invention is not limited to the illustrated examples.

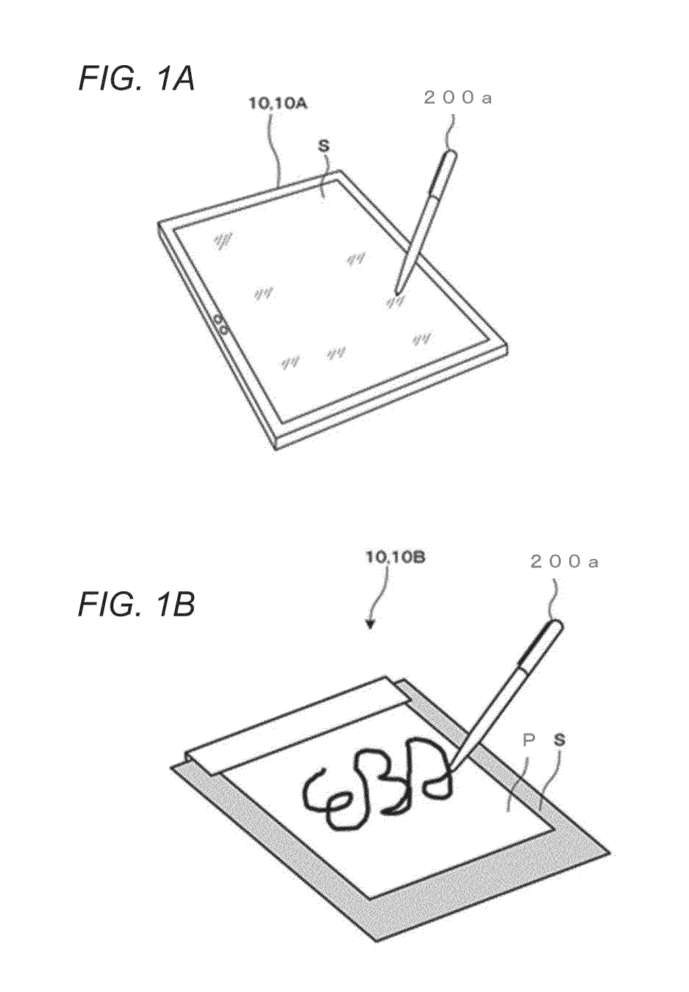

As illustrated in FIG. 1, an input apparatus 10 according to an embodiment of the present invention includes a function to receive handwriting input performed with a pen 200a by a user, a function to erase, when receiving erasing operation performed with an eraser, contents of handwriting input in a corresponding part, a function to detect operation such as a flick (FLICK) performed with a finger by a user, and the like.

As illustrated in FIG. 1A, the input apparatus 10 may be configured as a tablet terminal 10A which includes a touch panel (detection surface S) on a display surface such as a liquid crystal display. Alternatively, as illustrated in FIG. 1B, the input apparatus 10 may be configured as an underlay-type input apparatus 10B which includes a rectangular and tabular flat underlay-type touch panel including no display function and which receives handwriting input performed with the pen 200a or the like on the paper P or the like placed on the detection surface S.

The input apparatus 10 includes, for example, an input member determination function to automatically determine, based on a load (writing pressure) received from the input member, which input member is used among a pen, an eraser, and a finger to perform an input and an instruction determination function to determine a kind of input operation (such as flick or pinch-out) while taking the load (writing pressure) received from the input member into consideration when the input is performed with a finger. In the present description, various kinds of determination, which is performed relative to an input and which includes determination of a kind of an input member and determination of a kind of input operation, are generically referred to as determination related to an input. The determination related to an input is not limited to the above-described determination of a kind of an input member or determination of a kind of input operation and may be, for example, determination of a kind of drawing such as a straight line, a wavy line, or a dashed line or a kind of paint operation such as filling or erasing using an eraser.

The input apparatus 10 includes a function to detect a held state of the own apparatus whether the own apparatus is placed on a table or which part of the own apparatus is grasped and held by a hand and to switch a load range of a determination reference used for an input determination function or an instruction determination function according to a current held state.

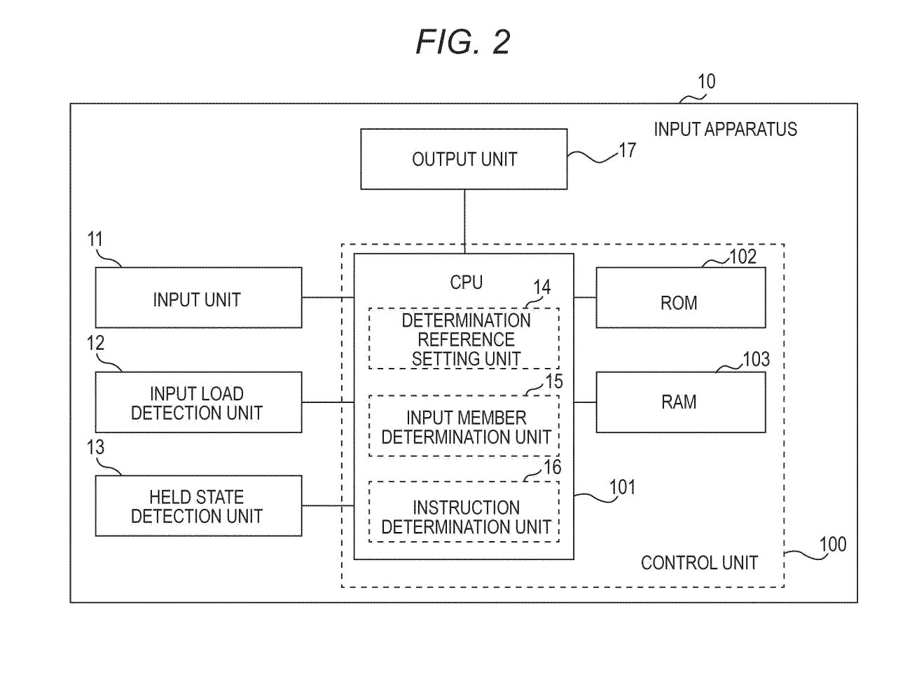

FIG. 2 is a block diagram illustrating a schematic configuration of the input apparatus 10. The input apparatus 10 includes an input unit 11 as a touch panel to detect a part where an input member such as a pen, a finger, or an eraser is in contact with the detection surface S, an input load detection unit 12 to detect a load (hereinafter, also referred to as writing pressure) which is applied by the input member to the detection surface S of the touch panel, a held state detection unit 13 to detect a held state of the input apparatus 10 based on an inclination of the input apparatus 10 or a position of a grasping hand, a determination reference setting unit 14 to change an original value by setting a determination reference value according to a held state of the input apparatus 10, an input member determination unit 15 to determine a kind of the input member, an instruction determination unit 16 to determine, when the input member is a finger, a kind of received input operation performed with the finger, and an output unit 17 to output a result of the determination by the input member determination unit 15 or the instruction determination unit 16 or handwritten contents.

A load detection unit 12 detects a pressing load relative to the input unit 11 and includes, for example, a deformation gauge sensor.

The held state detection unit 13 includes a gyroscope or a camera to detect an inclination of the own apparatus, a pressure sensor arranged on a rear surface of a main body, and the like. For example, when the inclination is substantially horizontal or when the whole pressure sensor on the rear surface detects pressure, it is determined that the own apparatus is placed on a table. On the other hand, when it is detected that the own apparatus is inclined for a certain degree or more or when only a part of the pressure sensor detects pressure, it is determined that a state is in a held state in which a part where the pressure is detected is grasped with a hand by a user.

The determination reference setting unit 14 changes setting of a load range to be a determination reference value to determine whether the input member is a pen, an eraser, or a finger or a load range to be a determination reference value to determine, when the input member is a finger, a kind of received input operation performed with the finger according to a current held state or according to the held state and an input part.

The input member determination unit 15 determines a kind of the input member by comparing the load range of the determination reference value set by the determination reference setting unit 14 with the detected writing pressure. When the input member is a finger, the instruction determination unit 16 determines a kind of the received input operation performed with the finger by comparing the load range of the determination reference value set by the determination reference setting unit 14 with the detected writing pressure.

The output unit 17 performs a function to perform a display corresponding to input contents or to output the input contents to an external display apparatus or information processing apparatus.

The input apparatus 10 includes a control unit 100 which includes a central processing unit (CPU) 101, a read only memory (ROM) 102, a random access memory (RAM) 103 and the like as a main part. When the CPU 101 executes a program stored in the ROM 102, various functions as the input apparatus 10 (specifically, function of determination reference setting unit 14, input member determination unit 15, and instruction determination unit 16) are realized. The program may be stored in a non-volatile storage medium such as an HDD or an SSD.

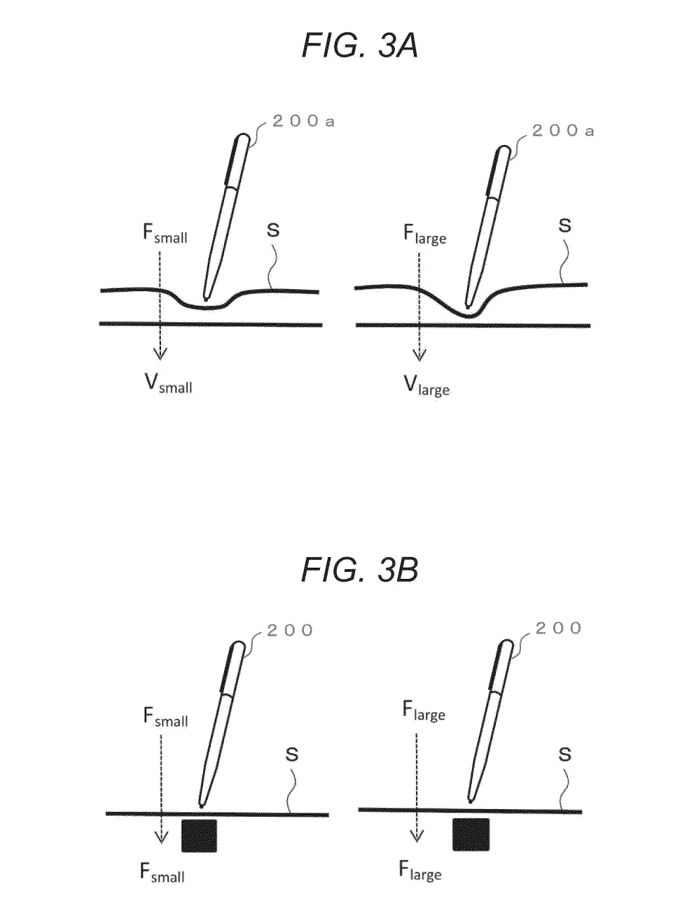

The input load detection unit 12 may be an arbitrary detection type as long as a load applied by the input member can be detected. FIG. 3A and FIG. 3B are views illustrating an example of various types of the input unit 11 and the input load detection unit 12.

(1) A type in which the input unit 11 to detect contact with the input member such as a pen or a finger or a movement of a contact part also includes a function of the input load detection unit 12.

FIG. 3A illustrates a resistance film-type touch panel. The resistance film-type touch panel temporarily deforms when the detection surface S thereof is pushed by the pen 200a or the like, and generates voltage corresponding to a degree of the deformation (heaviness of applied load). A left side of the view illustrates a case where the writing pressure is small and a right side of the view illustrates a case where the writing pressure is large. FIG. 3B is a view illustrating a pressure sensor-type touch panel. A pressure sensor is laid on the whole detection surface S.

(2) A type to provide the input load detection unit 12 other than the input unit 11 to detect contact with the input member or a movement of the contact part.

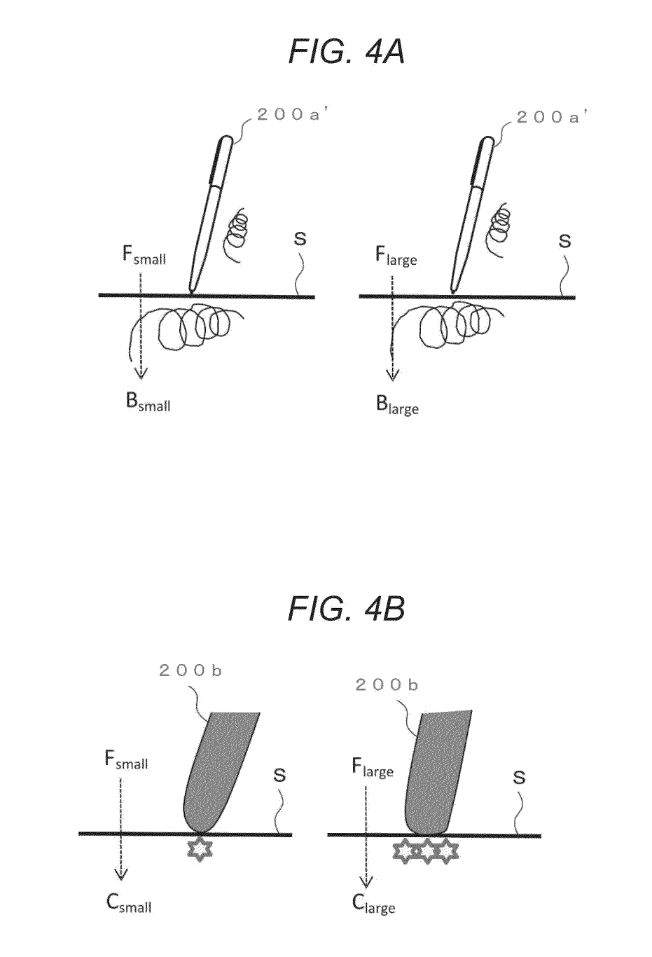

FIG. 4A is a view illustrating an electromagnetic induction-type touch panel. In the electromagnetic induction-type touch panel, coils are respectively provided to the detection surface S and to an electronic pen 200a′. By detecting a magnetic field generated when the coils become closer to each other, a distance between a touch position or the detection surface S and the electronic pen 200a′. When this type of touch panel is used, for example, a module to output a signal corresponding to a degree (strength) of contact with the detection surface S is mounted to the electronic pen 200a′ in order to detect the writing pressure. For example, writing pressure information is transmitted to the input apparatus 10 by wireless communication.

FIG. 4B is a view illustrating a capacitance-type touch panel. The capacitance-type touch panel detects a change in capacitance between a tip of a finger 200b and a conducting layer and acquires positional information. As a writing pressure detection method of when this type of touch panel is mounted, there is the following.

(A) A size of a contact surface which is in contact with the detection surface S of the touch panel can be detected as a change in capacitance. Thus, in respect to an input member, such as a finger, in which the size of the contact surface changes greatly according to a degree of the load, the change of the load can be detected by being replaced with a change in capacitance.

(B) Writing pressure is detected by laying a pressure sensor on the whole detection surface S or mounting, to the pen, a module to output a signal corresponding to a degree (strength) of contact with the detection surface S.

Next, a relationship between the writing pressure and a determination reference value (load range) of a kind of the input member in a held state in which the input apparatus 10 is placed on a table will be described.

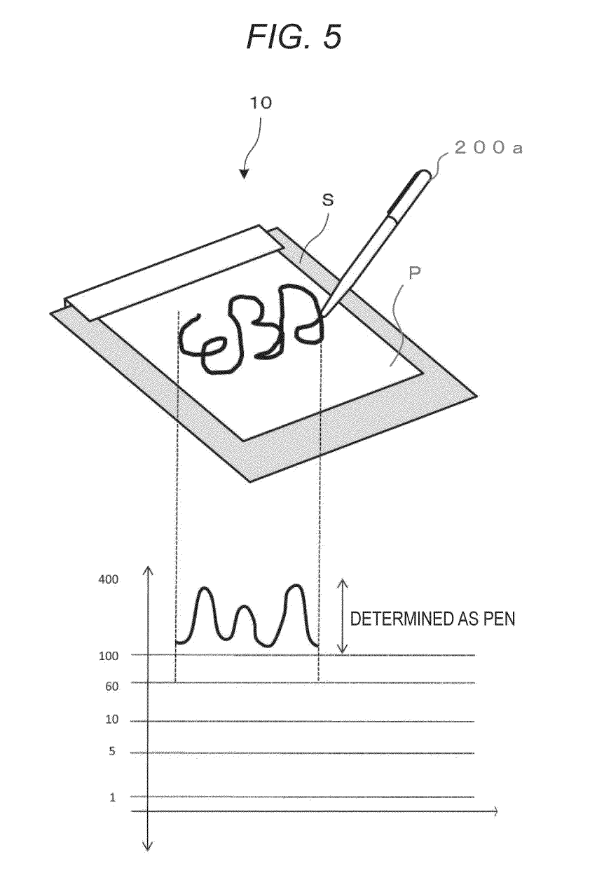

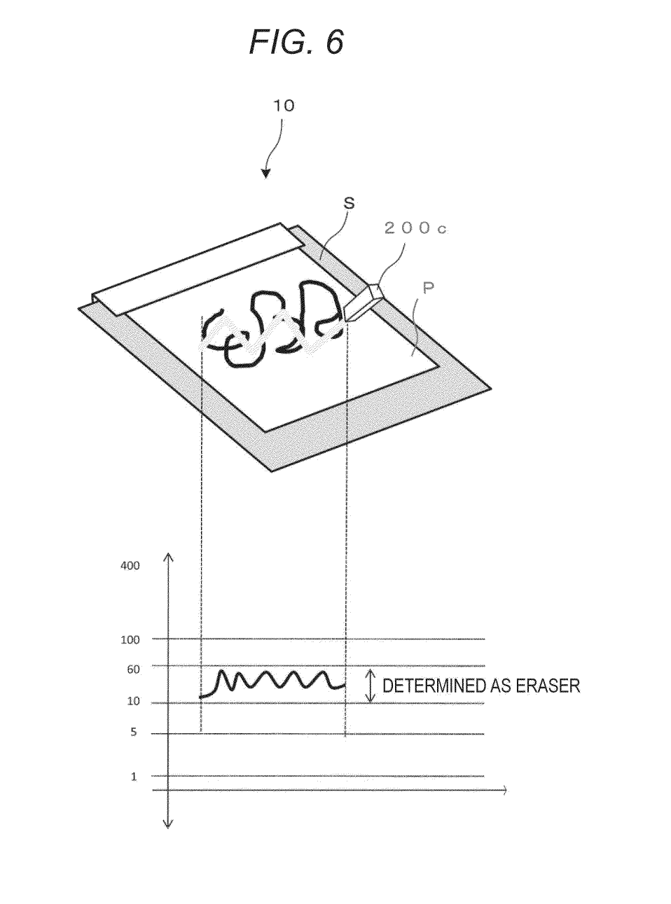

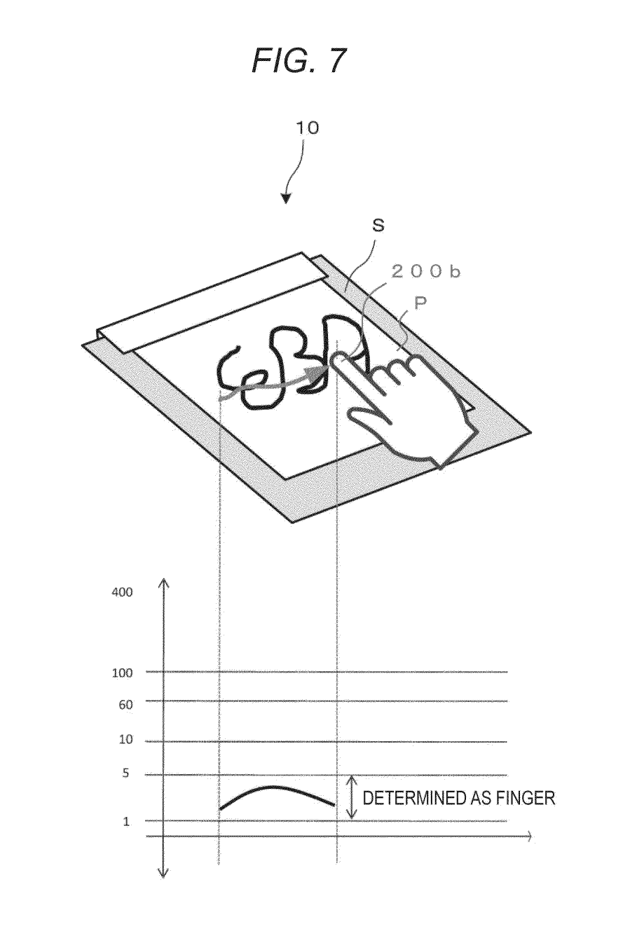

FIG. 5 to FIG. 7 are views respectively illustrating variation ranges of the load (writing pressure) in cases where an inputs are performed respectively with a pen, an eraser, and a finger while the input apparatus 10 is placed on a table. FIG. 5 is a view illustrating a case of the pen 200a, FIG. 6 is a view illustrating a case of an eraser 200c, and FIG. 7 is a view illustrating the finger 200b.

When a pen (such as pen in which grounding area with touch panel is 1 mm² or less and which has metal carbon-based material and high hardness) is used as the input member, a load applied to the touch panel during the input is in a range slightly narrower than 100 to 400 gf (see FIG. 5). Thus, when the input apparatus 10 is placed on a table, a load range to be a determination reference to determine that the input member is a pen is set as 100 to 400 gf. When a load (writing pressure) detected during the input transitions within the range of 100 to 400 gf, the input apparatus 10 determines that the input member is a pen.

When an eraser (such as eraser in which grounding area with touch panel is 5 mm² to 10 mm² and which has rubber-based material and low hardness) is used as the input member, a load applied to the touch panel during the input is in a range slightly narrower than 10 to 60 gf (see FIG. 6). Thus, when the input apparatus 10 is placed on a table, a load range to be a determination reference to determine that the input member is an eraser is set as 10 to 60 gf. When a load (writing pressure) detected during the input transitions within the range of 10 to 60 gf, the input apparatus 10 determines that the input member is an eraser.

When a finger (such as finger in which grounding area with touch panel is 11 mm² to 15 mm² and which has skin tissue and low hardness) is used as the input member, a load applied to the touch panel during the input is in a range slightly narrower than 1 to 5 gf (see FIG. 7). Thus, when the input apparatus 10 is placed on a table, a load range to be a determination reference to determine that the input member is a finger is set as 1 to 5 gf. When a load (writing pressure) detected during the input transitions within the range of 1 to 5 gf, the input apparatus 10 determines that the input member is a finger.

Next, a relationship between a load and a kind of operation in a case where the operation performed with a finger is received in the held state in which the input apparatus 10 is placed on a table will be described.

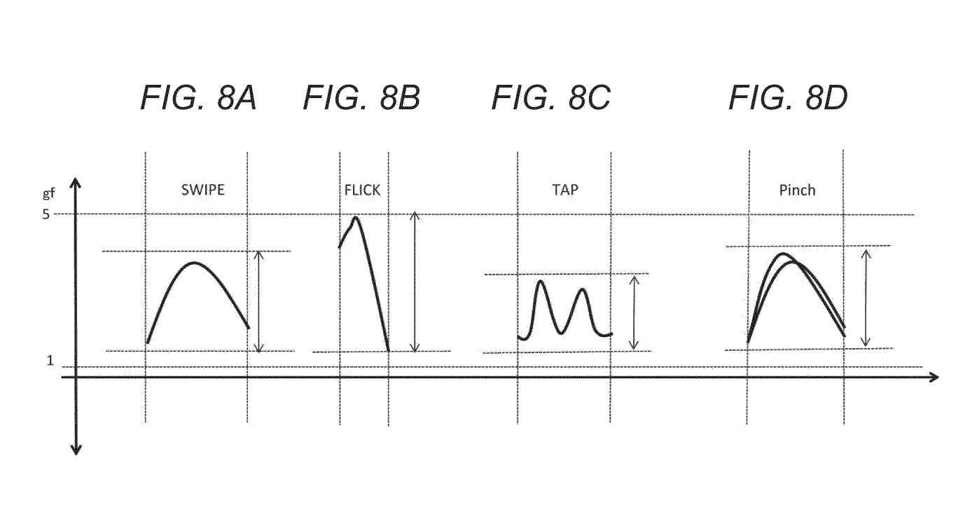

FIG. 8A to FIG. 8D are views respectively illustrating variation ranges of a load (writing pressure) in a case where various kinds of operation performed with a finger are received while the input apparatus 10 is placed on a table. FIG. 8A is a view illustrating a case of swipe operation (SWIPE), FIG. 8B is a view illustrating a case of flick operation (FLICK), FIG. 8C is a view illustrating a case of tap operation (TAP), and FIG. 8D is a view illustrating a case of pinch operation (Pinch).

In a case where operation performed with a finger is SWIPE, a load during the operation is within a range of 1 to 3 gf. Thus, when the load during the operation performed with the finger transitions within the range of 1 to 3 gf, the input apparatus 10 determines that the operation performed with the finger is SWIPE.

In a case where operation performed with a finger is FLICK, a load during the operation is within a range of 1 to 5 gf. Thus, when the load during the operation performed with the finger transitions within the range of 1 to 5 gf, the input apparatus 10 determines that the operation performed with the finger is FLICK.

In a case where operation performed with a finger is TAP, a load during the operation is within a range of 1 to 1.5 gf. Thus, when the load during the operation performed with the finger transitions within the range of 1 to 1.5 gf, the input apparatus 10 determines that the operation performed with the finger is TAP.

When the operation performed with a finger is Pinch, the finger is detected at two points during the input. Also, a load during the operation is within the range of 1 to 3 gf. Thus, when the operation performed with the finger is performed simultaneously at two points and the load during the operation transitions within the range of 1 to 3 gf, the input apparatus 10 determines that the operation performed with the finger is Pinch.

Next, a relationship between an input position and a load during the input in a held state in which the input apparatus 10 is held by a hand will be described.

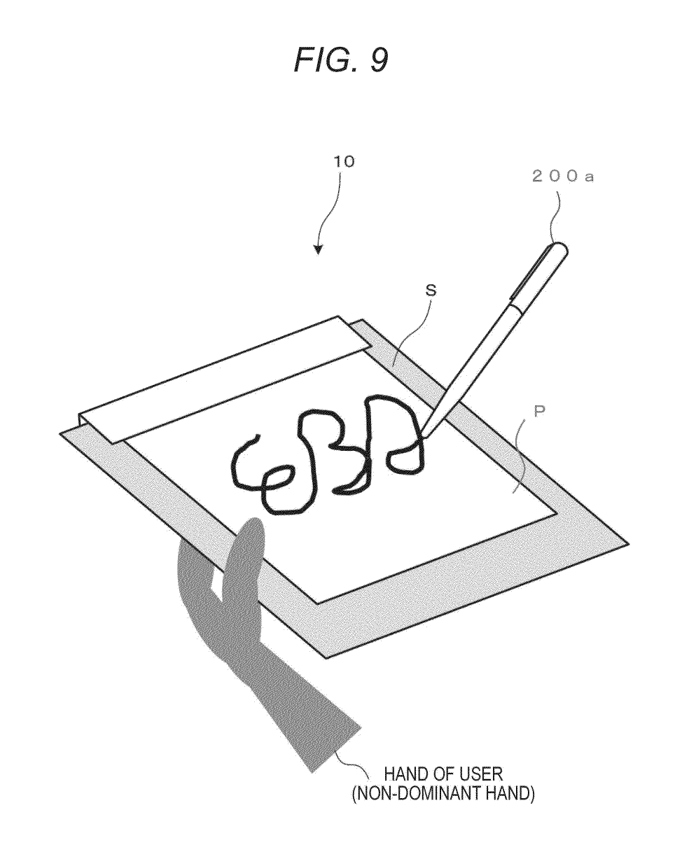

FIG. 9 is a view illustrating a state in which a user holds the input apparatus 10 with a non-dominant hand in such a manner to grasp around an end on an opposite side of a dominant hand. A user performs handwriting while holding the pen 200a with a dominant hand.

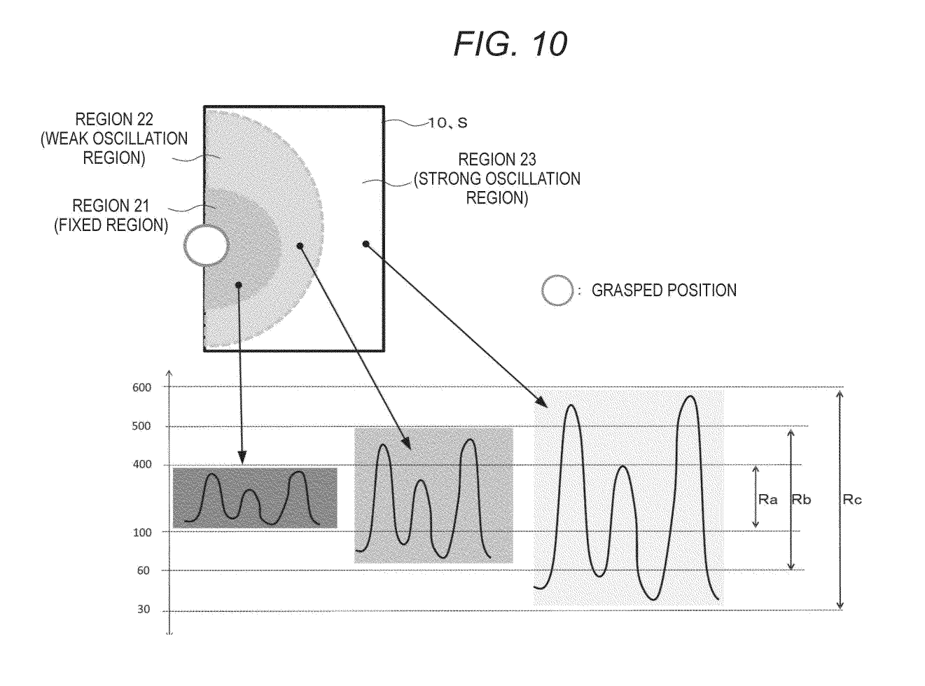

FIG. 10 is a view illustrating a state in which the detection surface S of the input apparatus 10 is divided into a plurality of regions according to the held state illustrated in FIG. 9 and illustrating a load range in a case where handwriting is performed in each region with a pen. A region 21 is a region including a part grasped by a user and a neighborhood thereof and is a region (assumed as fixed region) where the detection surface S does not move or rarely moves even when a load due to the handwriting input is received. Here, the region 21 is substantially in a semicircle with the part grasped by the user as a center.

A region 22 is a region (region far from part grasped by non-dominant hand of user) on an outer side of the region 21 and is a region (assumed as weak oscillation region) where a pen is pushed back since the detection surface S is slightly pushed downward when a load due to the handwriting input is received, and a user adds slight upward pressure.

A region 23 is a region (region further away from part grasped by non-dominant hand of user) on an outer side of the region 22 and is a region (assumed as strong oscillation region) where a pen is strongly pushed back since the detection surface is strongly pushed when a load due to the handwriting input is received, and a user adds upward pressure.

In the region 21 which is a fixed region, a load of when an input is performed with a pen varies within the range of 100 to 400 gf. Thus, when an input is performed in the fixed region, a load range Ra to be a determination reference to determine that the input member is a pen is set as the range of 100 to 400 gf.

In the weak oscillation region (region 22), a load of when an input is performed with a pen varies within a range of 60 to 500 gf. Thus, when an input is performed in the weak oscillation region, a load range Rb to be a determination reference to determine that the input member is a pen is set as the range of 60 to 500 gf.

In the strong oscillation region (region 23), a load of when an input is performed with a pen varies within a range of 30 to 600 gf. Thus, when the input is performed in the strong oscillation region, a load range Rc to be a determination reference to determine that the input member is a pen is set as the range of 30 to 600 gf.

For example, in a case where a determination reference Ra of the fixed region is applied to all input positions regardless of the input positions, an input within a range of 30 to 100 gf and that within a range of 400 to 600 gf are not determined as inputs performed with a pen when handwriting is performed with a pen in the strong oscillation region. However, in the input apparatus 10 according to the present embodiment, as described above, a kind of the input member can be determined appropriately at each input position since a load range to be a determination reference is switched according to the input position when the input apparatus 10 is held by a hand.

Next, a relationship between a load and a kind of operation in a case where the operation is performed with a finger while the input apparatus 10 is in the held state illustrated in FIG. 9 will be described.

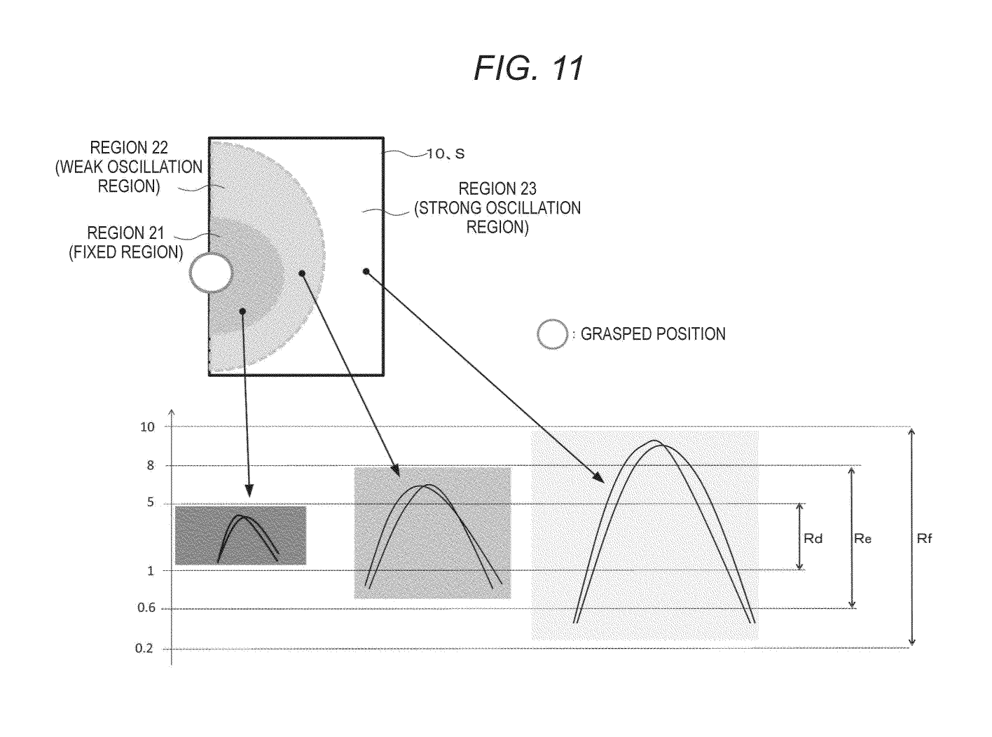

FIG. 11 is a view illustrating division (which is same with that in FIG. 7) corresponding to the held state illustrated in FIG. 9 and also illustrating a load range of when Pinch operation performed with a finger is received in each of the regions 21 to 23.

When Pinch operation is received in the region 21 which is a fixed region, a load is detected at two points. The load is within a range slightly narrower than 1 to 5 gf. Thus, when an input is performed with a finger in the fixed region, a load range Rd to be a determination reference to determine that the operation is Pinch operation is set as the range of 1 to 5 gf.

When the Pinch operation is received in the weak oscillation region (region 22), a load is detected at two points. The load is within a range slightly narrower than 0.8 to 7 gf. Thus, when an input is performed with a finger in the weak oscillation region, a load range Re to be a determination reference to determine that the operation is Pinch operation is set as the range of 0.8 to 7 gf.

When the Pinch operation is received in the strong oscillation region (region 23), a load is detected at two points. The load is within a range slightly narrower than 0.3 to 10 gf. Thus, when an input is performed with a finger in the strong oscillation region, a load range Rf to be a determination reference to determine that the operation is Pinch operation is set as the range of 0.3 to 10 gf.

For example, in a case where the determination reference (1 to 5 gf) of the fixed region is applied to all input positions regardless of the input positions, when the Pinch operation performed with a finger is received in the strong oscillation region, an input within a range of 0.2 to 1 gf and that within a range of 5 to 10 gf are not recognized as a finger. Even when a finger is detected only within the range of 1 to 5 gf, the detected operation and the Pinch operation are not identical to each other. Accordingly, it is not determined that the Pinch operation is performed. However, in the input apparatus 10 of the present embodiment, as described above, the Pinch operation performed with a finger can be detected appropriately in each input position since a load range to be a determination reference of the Pinch operation is switched according to an input position when the input apparatus 10 is held by a hand.

Next, a case where a way of dividing into regions is switched according to a way of holding by a hand will be described.

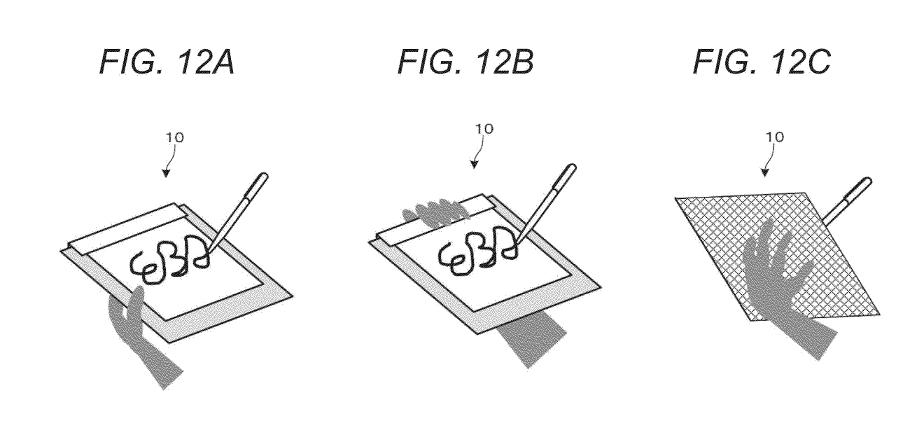

FIG. 12A to FIG. 12C are views illustrating various ways of holding by a hand. FIG. 12A is a view illustrating a held state (first held state) which is the same with that in FIG. 9. FIG. 12B is a view illustrating a held state (second held state) in a case where an upper end of the input apparatus 10 is held by a non-dominant hand and a rear surface of the input apparatus 10 is supported and fixed from the upper end to a lower end thereof by an arm. FIG. 12C is a held state (third held state) in a case where the rear surface of the input apparatus 10 is supported and fixed by a palm of the non-dominant hand.

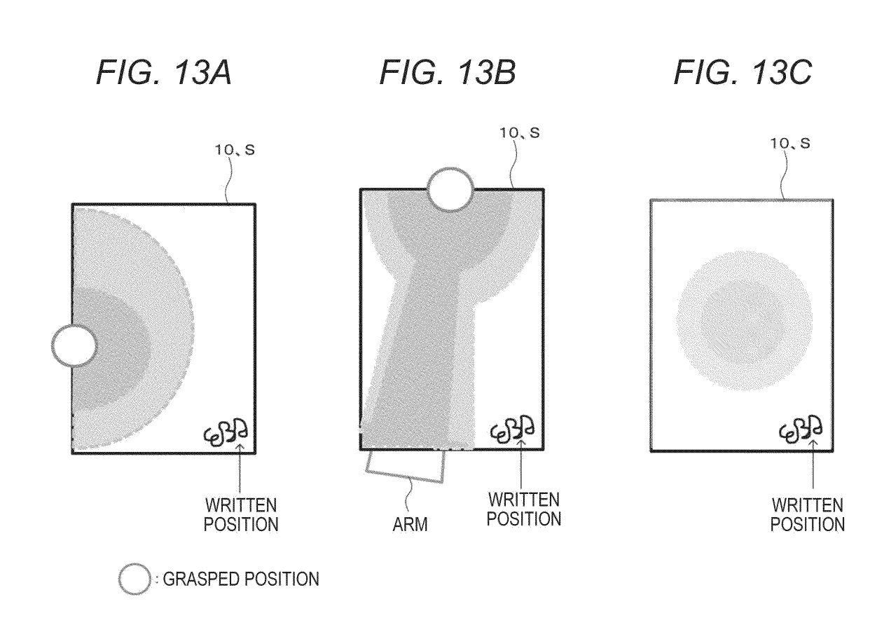

FIG. 13A to FIG. 13C are views illustrating a way of dividing into regions in each of the held states illustrated in FIG. 12A to FIG. 12C. In FIG. 13A, a way of dividing into regions is the same with that in the first held state in FIG. 12A (which is same with that in FIG. 9). FIG. 13B is a view illustrating a way of dividing into regions in the second held state in FIG. 12B. FIG. 13C is a view illustrating a way of dividing into regions in the third held state in FIG. 12C.

As illustrated in FIG. 13A, in the first held state, a fixed region is distributed in a substantially semicircular manner with a grasped one part as a center and fixity is decreased as a distance from the grasped part becomes longer.

As illustrated in FIG. 13B, in the second held state, not only a grasped part on the upper end of the input apparatus 10 but also the rear surface of the input apparatus 10 are supported by an arm diagonally downward from a center in an upper part toward the left. Thus, compared to the first held state, a fixed region is wide. As a distance from the grasped part and the part supported by the arm becomes longer, fixity is decreased.

As illustrated in FIG. 13C, in the third held state, a fixed region is distributed in a substantially circular region corresponding to a part, which is supported by a palm, at a center of the rear surface of the input apparatus 10 and fixity is decreased as a distance therefrom becomes longer.

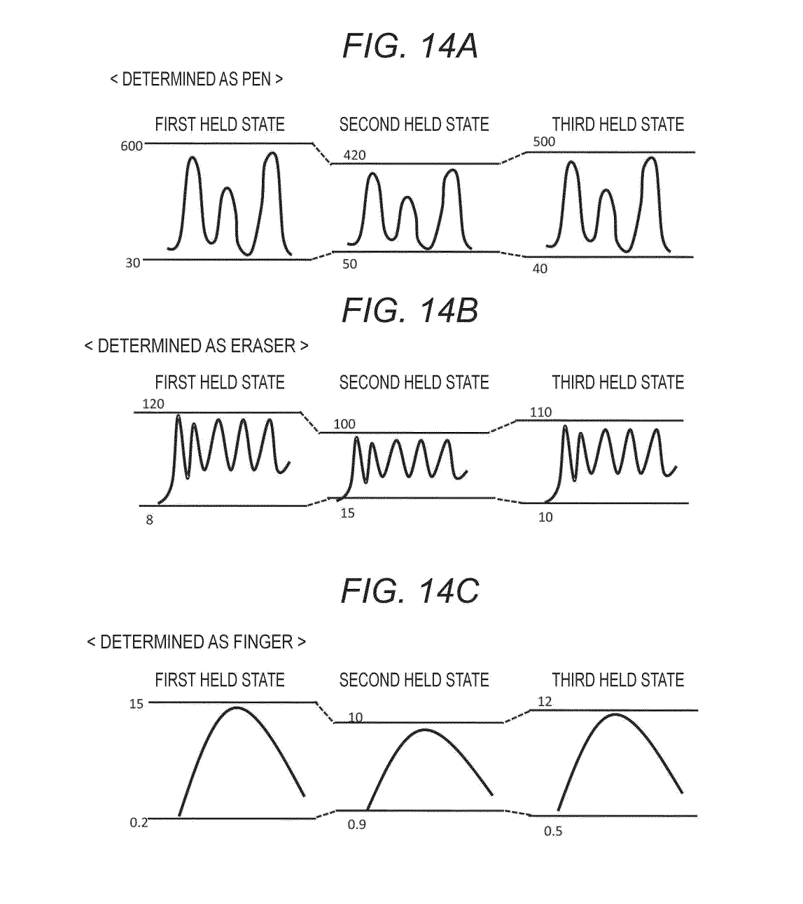

FIG. 14A is a view illustrating a variation range of a load and a determination reference value (load range) in a case where handwriting is performed with a pen in a strong oscillation region in each of the first to third held states. FIG. 14B is a view illustrating a variation range of a load and a determination reference value (load range) in a case where operation to ease is performed with an eraser in the strong oscillation region in each of the first to third held states. FIG. 14C is a view illustrating a variation range of a load and a determination reference value (load range) in a case where an input is performed with a finger in the strong oscillation region in each of the first to third held states.

The strong oscillation region is a region where pushing/pushing back is performed in the strongest manner. In the first to third held states, writing is performed in the same position (in strong oscillation region) on the detection surface S (see FIG. 13A to FIG. 13C). However, since strength of the pushing/pushing back varies depending on the held state, a load range received during the input varies from each other slightly. As illustrated in FIG. 14A to FIG. 14C, a magnitude relationship relative to a width of the load range is the second held state<the third held state<the first held state.

A determination reference value (load range) to determine that the input member is a pen in a case where writing is performed in the strong oscillation region is set within the range of 30 to 600 gf in the first held state, within a range of 50 to 420 gf in the second held state, and within a range of 40 to 500 gf in the third held state.

A determination reference value (load range) to determine that the input member is an eraser in a case where writing is performed in the strong oscillation region is set within a range of 8 to 120 gf in the first held state, within a range of 15 to 100 gf in the second held state, and within a range of 10 to 110 gf in the third held state.

A determination reference value (load range) to determine that the input member is a finger in a case where writing is performed in the strong oscillation region is set within a range of 0.2 to 15 gf in the first held state, within a range of 0.9 to 10 gf in the second held state, and within a range of 0.5 to 12 gf in the third held state.

Even when an input is performed in the same place, a degree of fixity in the place varies depending on the held state. Thus, a load during the input varies. For example, in a state in which a determination reference value (load range) relative to the strong oscillation region in the second held state is set, when an actual held state of the input apparatus 10 is the first held state, a load range to determine that the input member is a pen is up to 50 gf. However, an actual load may be 30 gf, and thus, a part input within a range of 30 to 50 gf is determined as an input performed with an eraser. In the present embodiment, since a determination reference value is switched according to the held state, false recognition of a kind of the input member can be eliminated in a further secure manner.

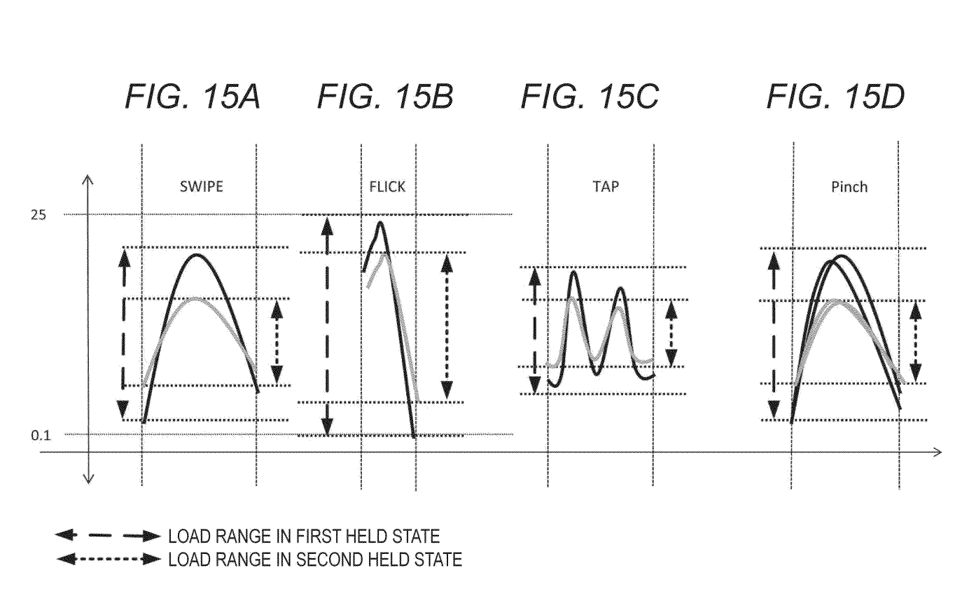

FIG. 15A to FIG. 15D are views illustrating load ranges relative to various kinds of operation in a case where input operation is performed with a finger in the strong oscillation region in different held states. FIG. 15A is a view illustrating a variation range of a load and a determination reference value in a case where SWIPE operation is performed with a finger in the strong oscillation region in the first held state and the second held state. When the SWIPE operation is performed with a finger in the strong oscillation region in the first held state, the load varies within the range of 0.2 to 15 gf. Thus, a determination reference value (load range) to determine that operation performed with a finger in the strong oscillation region in the first held state is the SWIPE operation is set as the range of 0.2 to 15 gf.

When the SWIPE operation is performed with a finger in the strong oscillation region in the second held state, the load varies within the range of 0.9 to 10 gf. Thus, a determination reference value (load range) to determine that operation performed with a finger in the strong oscillation region in the second held state is the SWIPE operation is set as the range of 0.9 to 10 gf.

FIG. 15B is a view illustrating a variation range of a load and a determination reference value in a case where FLICK operation is performed with a finger in the strong oscillation region in the first held state and the second held state. When the FLICK operation is performed with a finger in the strong oscillation region in the first held state, the load varies within a range of 0.1 to 22 gf. Thus, a determination reference value (load range) to determine that operation performed with a finger in the strong oscillation region in the first held state is the FLICK operation is set as the range of 0.1 to 22 gf.

When the FLICK operation is performed with a finger in the strong oscillation region in the second held state, the load varies within a range of 0.7 to 15 gf. Thus, a determination reference value (load range) to determine that operation performed with a finger in the strong oscillation region in the second held state is the FLICK operation is set as the range of 0.7 to 15 gf.

FIG. 15C is a view illustrating a variation range of a load and a determination reference value in a case where TAP operation is performed with a finger in the strong oscillation region in the first held state and the second held state. When the TAP operation is performed with a finger in the strong oscillation region in the first held state, the load varies within a range of 0.5 to 10 gf. Thus, a determination reference value (load range) to determine that operation performed with a finger in the strong oscillation region in the first held state is the TAP operation is set as the range of 0.5 to 10 gf.

When the TAP operation is performed with a finger in the strong oscillation region in the second held state, the load varies within a range of 0.9 to 7 gf. Thus, a determination reference value (load range) to determine that operation performed with a finger in the strong oscillation region in the second held state is the TAP operation is set as the range of 0.9 to 7 gf.

FIG. 15D is a view illustrating a variation range of a load and a determination reference value in a case where Pinch operation is performed with a finger in the strong oscillation region in the first held state and the second held state. When the Pinch operation is performed with a finger in the strong oscillation region in the first held state, the load varies within the range of 0.2 to 15 gf. Thus, a determination reference value (load range) to determine that operation performed with a finger in the strong oscillation region in the first held state is the Pinch operation is set as the range of 0.2 to 15 gf.

When the Pinch operation is performed with a finger in the strong oscillation region in the second held state, the load varies within the range of 0.9 to 10 gf. Thus, a determination reference value (load range) to determine that operation performed with a finger in the strong oscillation region in the second held state is the Pinch operation is set as the range of 0.9 to 10 gf.

Similarly to a case of the input performed with a pen, even when input operation performed with a finger is received in the same place, a degree of fixity varies depending on the held state. Thus, a load during the input varies. For example, in a case where the SWIPE operation is received in a setting state of a determination reference (load range) relative to the strong oscillation region in the second held state, when an actual held state of the input apparatus 10 is the first held state, a range of 0.2 to 0.9 gf and a range of 10 to 15 gf are not detected as operation during the SWIPE operation. Thus, a movement of detected input operation is not identical to a movement of the SWIPE operation and appropriate processing is not performed. In the present embodiment, since a determination reference value relative to input operation is also switched according to the held state, false recognition of the input operation can be prevented.

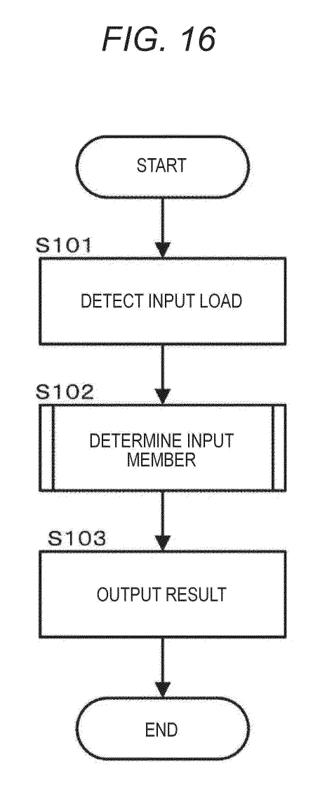

FIG. 16 is a flowchart illustrating an outline of whole processing performed by the input apparatus 10. When receiving any kind of input on the detection surface S, the input apparatus 10 detects a load of the input and quantifies the detected load of the input (step S101). Then, a kind of an input member used for the input is determined (step S102). Then, processing corresponding to a result of the determination in step S102 is performed (step S103).

That is, in a case of a pen, an object corresponding to a trace of handwriting is displayed or information of the object is output to an external apparatus. In a case of an eraser, a display on a part corresponding to an input trace is erased or an instruction to erase the part is output to the outside. In a case where it is determined that the input member is a finger, operation contents such as SWIPE, FLICK, TAP, and Pinch are specified and processing corresponding to the operation contents such as performing scaling or scrolling of a display is performed.

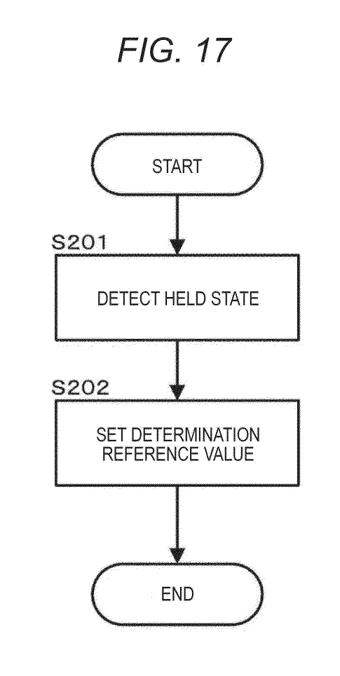

FIG. 17 is a flowchart illustrating processing by the input apparatus 10 to perform switching of a determination reference value according to a held state of the own apparatus. The input apparatus 10 detects a held state of the own apparatus (step S201) and sets a determination reference value corresponding to the held state (step S202). The processing is performed repeatedly in a short period of time and a determination reference value corresponding to a current held state is set constantly.

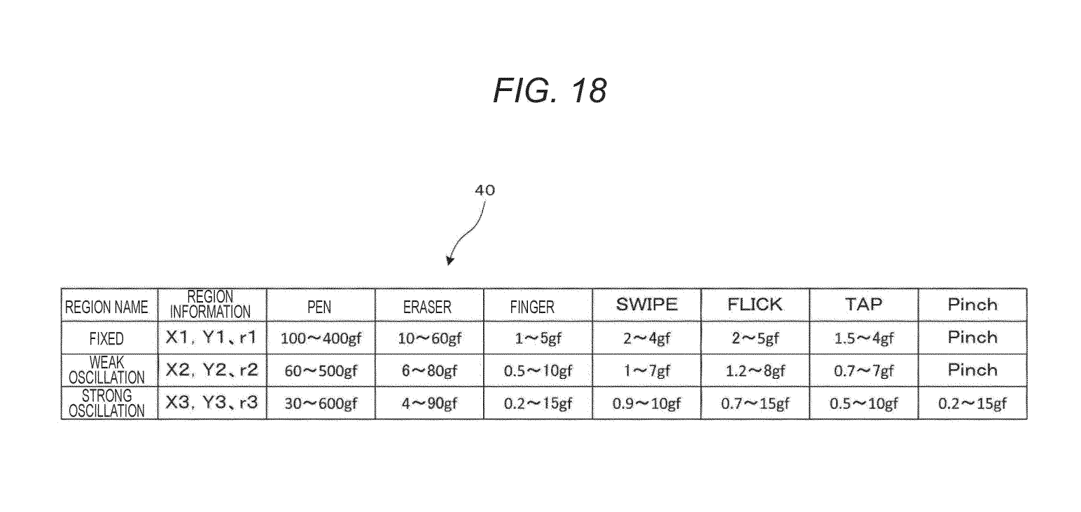

FIG. 18 is a table illustrating an example of a determination reference value table 40 in which a determination reference value is registered. A plurality of kinds of determination reference value tables 40 is respectively prepared for held states. A determination reference value table 40 corresponding to a current held state is selected and enabled. In one determination reference value table 40 corresponding to one held state, a region name, region information indicating a place of the region on the detection surface S, a load range to determine that an input member is a pen, a load range to determine that the input member is an eraser, a load range to determine that the input member is a finger, a load range to determine that operation is the SWIPE operation, a load range to determine that operation is the FLICK operation, a load range to determine that operation is the TAP operation, a load range to determine that operation is the Pinch operation, and the like are registered for each region.

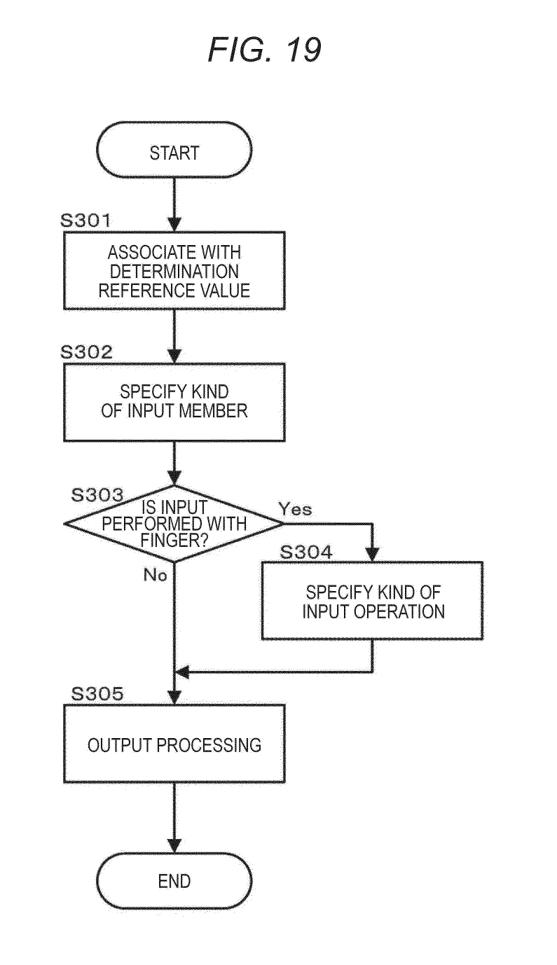

FIG. 19 is a flowchart illustrating a detail of step S102 in FIG. 16. The load detected in step S101 in FIG. 16 is compared with a current determination reference value (step S301). Specifically, a place of each region, which place is indicated in the determination reference value table 40 set according to the current held state, is compared with a position where an input load is detected and a kind of a region (fixed region, weak oscillation region, or strong oscillation region) of a position where the input load is detected is specified. Next, a determination reference value (load range of each of pen, eraser, and finger) corresponding to the specified region and the variation range of the load detected in step S101 are compared with each other and a kind of the input member is specified (step S302).

When the input member is not a finger (step S303; No), processing goes to step S305. When the input member is a finger (step S303; Yes), a kind of input operation performed with the finger is determined (step S304) and processing goes to step S305. Specifically, in step S304, the set determination reference value table 40 is referred to and a load range of each kind of input operation corresponding to the region where the input load is detected is compared with a variation range of the load detected in step S101, whereby a kind of the input operation is specified.

In step S305, a result of the determination is output. That is, information indicating the kind of the input member is notified to the processing in FIG. 16 and the present processing is completed. In a case where the input member is a finger, information indicating the kind of the input operation is also notified. For example, the present processing is completed with the above information as a return value and processing goes back to the processing in FIG. 16.

In the above, an embodiment of the present invention has been described with reference to the drawings. However, a detail configuration is not limited to what illustrated in the embodiment and modification or addition within the spirit and the scope of the present invention can be made.

In the embodiment, a load received from the input member is detected and a load range to be a determination reference value of a kind of the input member or a kind of the input operation is switched according to a held state. However, a control parameter switched according to the held state is not limited to the above.

For example, a size of deviation of a trace generated when a straight line is handwritten also varies due to a held state. When the input apparatus 10 performs correction processing to correct deviation of a trace within a reference range and to replace with a straight line, a width of the reference range is switched according to a held state of the input apparatus 10 or a region to which a position where a handwriting input is performed belongs.

In the embodiment, three kinds of input members which are a pen, an eraser, and a finger are determined, but an input member to be determined is not limited thereto. Also, input operation performed with a finger is not limited to what illustrated as an example in the embodiment.

As the held state, the first to third held states are illustrated as examples in addition to a case where the input apparatus 10 is placed on a table. However, an embodiment of the held state is not limited to the above.

The present application is based on Japanese Patent Application No. 2013-255334 filed on Dec. 10, 2013 and the disclosure thereof as a whole is incorporated herein by reference.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An input apparatus comprising:
a held state detection unit configured to detect a held state of an own apparatus;
an input detection unit including a detection surface configured to detect an input performed by contact with an input member;
a determination unit configured to perform determination related to the input detected by the input detection unit; and
a determination reference setting unit configured to set, according to the held state detected by the held state detection unit, a determination reference used by the determination unit for the determination.

2. The input apparatus according to claim 1, wherein the input detection unit detects a load value received on the detection surface from the input member, and
the determination reference setting unit sets the load value as the determination reference.

3. The input apparatus according to claim 2, wherein the determination unit performs the determination by using, as the determination reference, determination whether the load value detected by the input detection unit is within a predetermined range.

4. The input apparatus according to claim 1, wherein the determination reference setting unit sets the determination reference according to the held state detected by the held state detection unit and a position where the input is detected.

5. The input apparatus according to claim 1, wherein the determination unit determines a kind of the input member as determination related to the input.

6. The input apparatus according to claim 5, wherein the determination unit performs, as the determination related to the input, at least one kind of determination among determination whether the input member is a pen, determination whether the input member is a finger, and determination whether the input member is an eraser.

7. The input apparatus according to claim 1, wherein the determination unit determines, as the determination related to the input, a kind of input operation.

8. The input apparatus according to claim 7, wherein the determination unit performs, as the determination related to the input, at least one kind of determination among determination whether the input operation is a swipe, determination whether the input operation is a flick, determination whether the input operation is a tap, and determination whether the input operation is a pinch.

9. The input apparatus according to claim 7, wherein the held state detection unit detects whether the held state is a state in which the input apparatus is held in such a manner that an end part on an opposite side of a dominant hand of a user is grasped, a state in which an upper end part is grasped and the upper end part to a lower end part of a rear surface of the input apparatus is supported and fixed by an arm of the user, a state in which the rear surface of the input apparatus is supported and fixed by a palm of the user, or a state in which the input apparatus is placed on a table

10. An input determination method in an input apparatus configured to detect an input performed by contact with an input member, comprising:
detecting a held state of the input apparatus;
setting, according to the detected held state, a determination reference for determination related to the input;
detecting the input performed with the input member; and
performing determination related to the detected input by using the set determination reference.

11. The input determination method according to claim 10, further comprising detecting a load value received from the input member and setting the load value as the determination reference.

12. The input determination method according to claim 11, further comprising performing the determination based on determination whether the detected load value is within a predetermined range.

13. The input determination method according to claim 10, further comprising setting the determination reference according to the detected held state and a position where the input is detected.

14. The input determination method according to claim 10, further comprising determining a kind of the input member.

15. The input determination method according to claim 14, further comprising performing at least one kind of determination among determination whether the input member is a pen, determination whether the input member is a finger, and determination whether the input member is an eraser.

16. The input determination method according to claim 10, further comprising determining a kind of input operation.

17. The input determination method according to claim 16, further comprising performing at least one kind of determination among determination whether the input operation is a swipe, determination whether the input operation is a flick, determination whether the input operation is a tap, and determination whether the input operation is a pinch.

18. A non-volatile computer-readable recording medium storing a program for causing a control circuit to function, in an input apparatus including a held state detection unit configured to detect a held state of an own apparatus, an input detection unit including a detection surface configured to detect an input performed by contact with an input member, and the control circuit configured to perform a calculation based on an output from each of the held state detection unit and the input detection unit, to set a determination reference for determination related to the input according to the held state of the input apparatus which state is detected by the held state detection unit and to perform the determination related to the input, which is performed with the input member and is detected by the input detection unit, by using the set determination reference.
